(19) United States
(12) Patent Application Publication
(10) Pub. No.: US 2002/0030359 A1
(43) Pub. Date: Mar. 14, 2002

(54) Fingerprint system

(76) Inventors: Jerker Bergenek, Lund (SE); Christer Fahraeus, Lund (SE); Linus Wiebe, Malmo (SE); Marten Obrink, Malmo (SE)

Correspondence Address: Cooper & Dunham LLP, 1185 Avenue of the Americas, New York City, NY, 10036, US

(21) Appl. No.: 09/835,468

(22) Filed: Apr. 16, 2001

Related U.S. Application Data
(63) Continuation-in-part of application No. 09/128,442, filed on Aug. 3, 1998, now Pat. No. 6,241,288.
(63) Continuation-in-part of application No. PCT/SE00/01472, filed on Jul. 11, 2000.
(63) Continuation-in-part of application No. PCT/SE01/00210, filed on Feb. 6, 2001.
(60) Provisional application No. 60/080,430, filed on Apr. 2, 1998.
(60) Provisional application No. 60/150,438, filed on Aug. 24, 1999.
(60) Provisional application No. 60/210,635, filed on Jun. 9, 2000.

(51) Int. Cl. B42D 15/00

(52) U.S. Cl. 283/68; 283/67; 283/69

(57) ABSTRACT

A fingerprint identification/verification system using bitmaps of a stored fingerprint to correlate with a bitmap of an input fingerprint, wherein an accurate reference point is located and selected two-dimensional areas in the vicinity of the reference point of the input image of the fingerprint are correlated with stored fingerprint recognition information to determine if the input fingerprint image and the stored fingerprint recognition information are sufficiently similar to identify/verify the input fingerprint.

This application is a continuation-in-part application of the U.S. Ser. No. 09/128,442 filed on Aug. 3, 1998, which in turn claims the benefit of U.S. Provisional Application No. 60/080,430 filed Apr. 2, 1998, and PCT Application No. PCT/SE00/01472 filed Jul. 11, 2000, which in turn claims the benefit of U.S. Provisional Application No. 60/150,438 filed Aug. 24, 1999 and PCT Application No. PCT/SE01/00210 filed Feb. 6, 2001, which in turn claims the benefit of U.S. Provisional Application No. 60/210 635 filed Jun. 9, 2000.

### BACKGROUND OF THE INVENTION

This invention relates generally to the field of fingerprint identification/verification systems. More particularly, this invention relates to a fingerprint identification/verification system using two dimensional bitmaps instead of traditional feature extraction.

Two types of matching applications are used for fingerprints. One-to-one verification is used to compare a fingerprint with either a particular template stored on, for example, a smart card, or a template recovered from a database by having the person provide his or her name, Personal Identification Number (PIN) code, or the like. One-to-many identification is used to compare a fingerprint to a database of templates, and is required when a person presents only his or her finger which is then compared to a number of stored images.

Traditional fingerprint identification by feature extraction has been used by institutions like the Federal Bureau of Investigation (FBI) for identifying criminals and is the most common fingerprint identification system. In feature extraction, the pattern of a fingerprint is checked for any special ‘features’ such as ridge bifurcations (splits) and ridge endings amongst the meandering ridges of the fingerprint. Once each such feature is identified, the location, that is, the distance and direction between the features, and perhaps the orientation of each feature, is determined. By storing only the feature location information, a smaller amount of data can be stored compared to storing the complete fingerprint pattern. However, by extracting and storing only the location of each feature, that is, the one-dimensional point on the fingerprint where the feature is located and, perhaps, the type of feature, information for security purposes is lost because all of the non-feature information is then unavailable for comparisons (matching).

Also, in order to determine the absolute location of the features, an unambiguous starting point is selected for the fingerprint. Traditional methods locate a ‘core point’. This core point is usually selected according to different criteria depending on the type of fingerprint, for example, whorl, circular or other type. Thus, a fingerprint in such a traditional system must first be classified as a known type before the core point can be determined and the features located.

### OBJECTS AND SUMMARY OF THE INVENTION

An object of the present invention is to provide a fingerprint identification system which identifies fingerprints more accurately than prior systems.

Another object of the present invention is to identify fingerprints by comparing entire two dimensional regions of fingerprint images rather than just the locations of features.

An additional object of the present invention is to accurately and efficiently find a reference point in the image from where to start the identification or verification process.

One or more of these objects may be achieved by a fingerprint enrollment method comprising the steps of obtaining an image of a fingerprint, selecting a first portion of the image, which has a predetermined relationship to a reference point, and storing a recognition template which comprises said first portion of the image.

One or more of these objects may furthermore be achieved by a fingerprint enrollment method, comprising the steps of obtaining an image of a fingerprint, selecting a plurality of portions of the image, and storing a recognition template of the fingerprint comprising said plurality of portions of the image.

One or more of these objects may also be achieved by a fingerprint enrollment method, comprising the steps of obtaining an image of a fingerprint, searching the image to obtain locations of fingerprint features, selecting at least one portion of the image, and storing a recognition template comprising the fingerprint feature locations and the at least one portion of the image.

One or more of these objects may also be achieved by a fingerprint matching method comprising the steps of obtaining a sample image of a fingerprint, correlating at least one image portion of a recognition template with at least part of the sample image to generate a correlation result, and determining whether the correlating result exceeds a predetermined matching requirement.

One or more of these objects may also be achieved by a fingerprint matching method comprising the steps of obtaining a sample image of a fingerprint, searching the sample image to obtain locations of fingerprint features, correlating the fingerprint feature locations of the sample image with fingerprint feature locations of a recognition template to obtain a first correlation result, determining a sample image reference point on the basis of the first correlation result, selecting a sample image portion in a predetermined relation to the sample image reference point and correlating the sample image portion with an image portion of the recognition template to obtain a second correlation result and determining whether the second correlation result exceeds a matching requirement.

One or more of these objects may also be achieved by a computer-readable memory medium, which comprises instructions for bringing a computer to carry out one or more of the above-described methods.

One or more of these objects may also be achieved by a fingerprint processing device, comprising a sensor for capturing an image of a fingerprint, a processor for receiving the image of the fingerprint captured by the sensor and for selecting a first portion of the image, said first portion having a predetermined relationship to a reference point, and a storage device for storing a recognition template of the fingerprint, which comprises said first portion of the image.

One or more of these objects may also be achieved by a fingerprint processing device comprising a sensor for capturing an image of a fingerprint, a processor for receiving the image of the fingerprint captured by the sensor and for correlating an image portion of a recognition template, which comprises at least one portion of another image, with at least part of the sample image to generate a correlation result, and determining whether the correlating result exceeds a predetermined matching requirement.

One or more of these objects may also be achieved by a fingerprint recognition template for a fingerprint processing system comprising a first portion of an image of a fingerprint, further portions of the image and relative location information corresponding to the location of each of the further image portions with respect to a predetermined reference location defined by the first image portion.

The above-mentioned objects and other objects, advantages, and features of the present invention will become apparent to those skilled in the art upon consideration of the following description of the present invention.

### BRIEF DESCRIPTION OF THE DRAWINGS

FIG. 1 is a schematical block diagram of a fingerprint processing system according to an embodiment of the present invention.

FIG. 2 is a flow diagram illustrating an enrollment process according to an embodiment of the present invention;

FIG. 3 is a binarized version of a captured image according to one embodiment of the present invention;

FIG. 4 is a vectorized version of the same captured image which is binarized in FIG. 3 according to one embodiment of the present invention;

FIG. 5 illustrates the possible sub-area orientations according to an embodiment of the present invention having eight possible orientations;

FIG. 6 illustrates the acceptable roof structures according to one embodiment of the present invention;

FIG. 7 illustrates the candidate sub-areas during a downward search according to one embodiment of the present invention;

FIG. 8 illustrates the possible acceptable left endpoints for an acceptable horizontal line structure according to one embodiment of the present invention;

FIG. 9 illustrates the possible acceptable right endpoints for an acceptable horizontal line structure according to one embodiment of the present invention;

FIG. 10 is a flow diagram illustrating a first horizontal line structure search according to one embodiment of the present invention;

FIG. 11 is a flow diagram illustrating a downward search for the reference point according to one embodiment of the present invention;

FIG. 12 is a flow diagram illustrating the scan of a structure to determine if the structure is acceptable according to one embodiment of the present invention;

FIG. 13 illustrates a first image portion, further image portions, and the location vectors for a recognition template according to one embodiment of the present invention;

FIG. 14 illustrates fingerprint feature locations, image portions and location vectors for a recognition template according to one embodiment of the present invention;

FIG. 15 is a flow diagram illustrating the matching process according to one embodiment of the present invention; and

FIG. 16 illustrates the matching procedure for both the first image portions and the further image portions according to one embodiment of the present invention.

### DETAILED DESCRIPTION OF THE INVENTION

While this invention is susceptible of embodiment in many different forms, the drawings show and the specification herein describes specific embodiments in detail. However, the present disclosure is to be considered as an example of the principles of the invention and is not intended to limit the invention to the specific embodiments shown and described. In the description below, like reference numerals are used to describe the same, similar or corresponding parts in the several views of the drawing.

The present invention is described below in three sections: (1) a fingerprint processing system, (2) an enrollment procedure; and(3) a matching procedure.

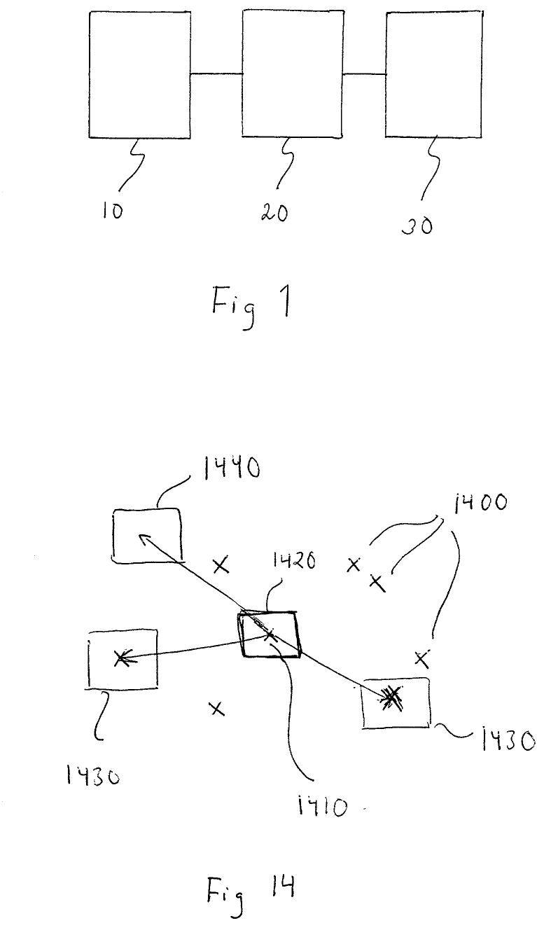

FIG. 1 schematically shows an example of a fingerprint system comprising a fingerprint sensor 10, a processor 20 and a template storage device 30. The sensor 10 can be for example, a heat sensor, a light sensor, an optical sensor, a capacitive sensor or a sensor based on any other technology used for sensing a fingerprint and providing an image thereof. The sensor 10 may be used for capturing a fingerprint image for enrollment or for matching. The purpose of the enrollment is to register an authorized person, the captured fingerprint image being used for producing a recognition template for the authorized person. The purpose of the matching is to check whether a person is authorized or not, the captured fingerprint image being matched against one or more recognition templates to establish if the fingerprint belongs to an authorized person. The sensor 10 is connected to the processor 20 which may be a microprocessor with sufficient read only memory (ROM) and random access memory (RAM) for operating on the image produced by the sensor, or a specifically adapted hardware, such as an Application Specific Integrated Circuit (ASIC) or a Field Programmable Gate Array (FPGA). The signal processor 20 is connected to the template storage device 30, which is used for storing one or more recognition templates. The template storage device may be a memory permanently or temporarily connected to or available to the processor 20. It may e.g. be a memory on a portable device, such as on a smart card, which can be read by a reader connected to or integrated with the processor. It may also be a memory permanently integrated with the processor. A smart card or similar device which is used for storing the template may also include a microprocessor or the like, which may be used for one or more steps in the enrollment and matching procedures. Finally it should be mentioned that some or all of the parts of the system may be arranged in a common casing.

Enrollment Procedure

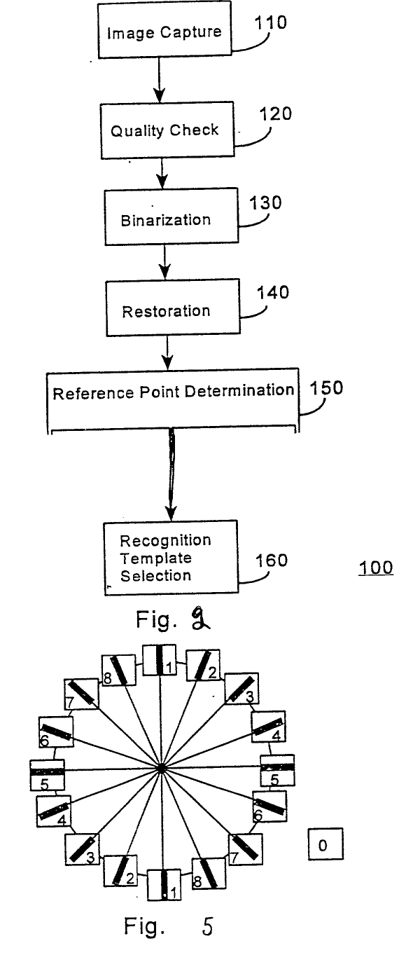

FIG. 2 illustrates a procedure for selecting information to be stored as a template by enrollment 100, for example to register authorized people, according to one embodiment of the present invention. In this embodiment, the captured image is a digital image. The enrollment procedure 100 is described below with respect to each step of the procedure.

Image Capture 110: The first step in enrollment 100 is to capture an fingerprint image with an image capturing device or sensor, e.g. sensor 10 i FIG. 1. If high security is required, such as for access to high-security computer network, the enrollment process 100 could be monitored while the person's fingerprint is placed on the sensor to ensure a high quality image is captured for storage as a template. Lower security, such as for access to an automatic teller machine (ATM) lobby, however, does not require as much, if any, supervision during enrollment 100 since a lower quality template can be tolerated.

Quality Check 120: First the image is checked to make sure that a fingerprint is present in the image. This check can be made by examining the frequencies in the image. If it is deemed that no fingerprint is present in the image, then the enrollment procedure is terminated. Second the location of the fingerprint in the image is checked by separating the background and the foreground. If the fingerprint location is not satisfactory, the person whose fingerprint is to be enrolled is prompted to place his finger on the sensor once again and the enrollment procedure is restarted. If the location is satisfactory, the fingerprint image is checked for dryness or wetness. If the image is ‘too dry’ the pressure applied to the sensor was too light or the sensor failed to detect parts of ridges because of fingertip dryness. If the image is ‘too wet’, moisture on the finger ‘flooded’ the fingerprint valleys. Wetness or dryness is detected by analysing the image for too few dark pixels (dryness) or, too many dark pixels and continuous dark areas (wetness). If the image is rejected, the person is asked to correct the problem and another image is taken.

Binarization 130: Once an image of the appropriate quality is captured 110, 120 the gray-level image is converted into a black-and-white (binarized) image, see FIG. 3, of the sensed fingerprint. This binarization is sensitive to the quality of the image. Binarization 130 is performed using a gray-scale threshold. Thus, for example, a pixel having a gray-scale value above a threshold value is determined to be black, and a pixel having a gray-scale value level below the threshold value is determined to be white. The threshold value can be global (the same threshold value is used for the entire image), or local (different threshold values are calculated separately for different areas of the image).

To aid in binarization 130, information from the ridge/valley directions may be used to enhance the binarized image. For example, an isolated pixel which has a gray-scale value just high enough to be considered black and thus, part of a ridge, could instead be set to white if all the surrounding pixels are considered to be in a valley. This enhancement is particularly useful for lower quality or noise-affected images. Both local thresholds and ridge/valley direction information from the same area may be combined as part of binarization 130.

Different kinds of gray-scale enhancement may also be carried out before the binarization is started.

A binarized version of the captured image is illustrated in FIG. 3. This binarized image is organized into an orthogonal grid 200 having rows 210 and columns 220 of picture elements or pixels. The rows 210, the horizontal orientation, are numbered in increasing order moving down from the part of the image corresponding to the part of the fingerprint closest to the fingertip; and the columns 220, the vertical orientation, are numbered in increasing order from left to right. Also, the terms ‘up’, ‘down’, ‘left’, ‘right’, and variations thereof, are used in this specification to refer to the top (lower row numbers), bottom (higher row numbers), leftside (lower column numbers), and rightside (higher column numbers), in an image, respectively. However, other types of images and image organizations, such as for example, a hexagonal grid or an analog image can also be used.

Restoration 140: Restoration is similar to, and is interconnected with, binarization 130. However, restoration 140 is performed after binarization 130. Basically, restoration 140 takes advantage of knowledge of how fingerprints are known to appear, for example, the generally continuous nature of fingerprint ridges. Techniques such as the use of local ridge/valley directions described above may also be used for restoration 140. Another restoration technique determines a pixel's value based on the particular combination of the neighboring pixel values. Other restoration methods consider and restore the image based on expected ridge/valley widths and other physical fingerprint characteristics.

Reference Point Determination 150: After the image is binarized 130 and restored 140, a reference point for the image may be determined.

In one embodiment of the present invention only two procedures are required. The first procedure is based on a vectorization of the gray-scale image. The second procedure, which may be used if the first procedure is unable to locate a reference point, locates the geographic center of the image. Alternatively, the second procedure can be based on counting the ridges in a binarized image, or on calculating fast Fourier transforms (FFTs) of the fingerprint image and selecting the point corresponding to the dominant frequencies, or on selecting a predetermined point in the image, i.e. in the coordinate system of the sensor. The second procedure may also be used as the sole method for determining a reference point, i.e. without the previous use of the first method.

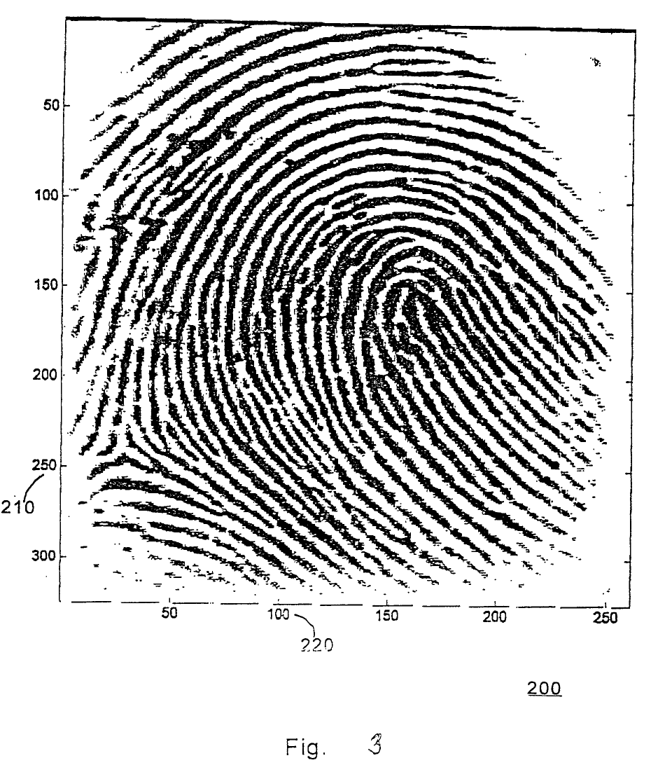

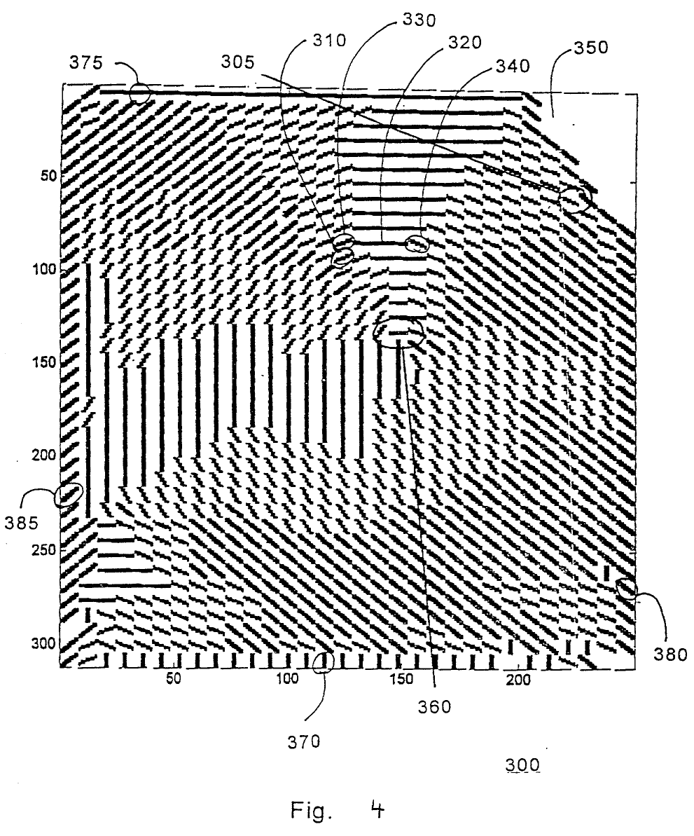

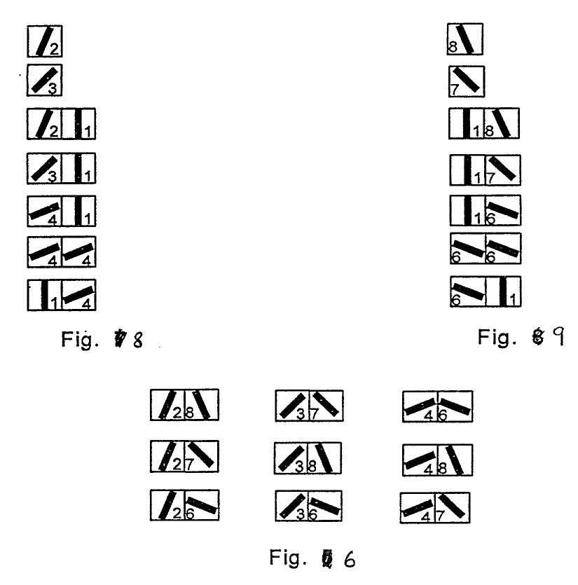

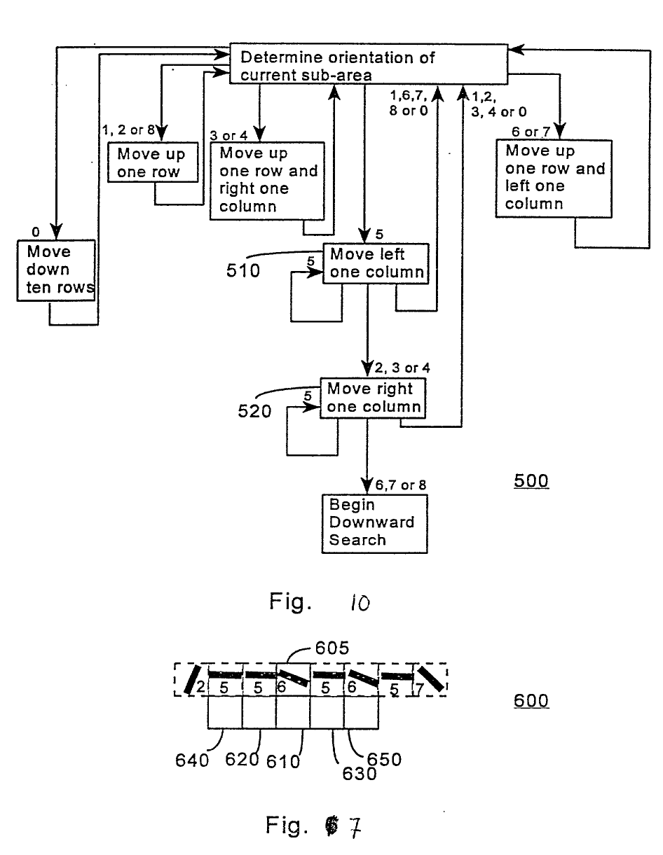

The first procedure locates a reference point from a vector representation of the gray-scale image, that is, a vectorized image 300. FIG. 4 illustrates such a vectorized image. Vectorization is performed by dividing the image into sub-areas and by assigning an orientation to each sub-area 305. FIG. 5 illustrates the possible sub-area orientations according to the embodiment of the present invention shown in FIG. 4. With this first procedure, the reference point is defined as either the center pixel of the last of the leftmost of two sub-areas of the image defining a ‘roof’ structure, or the center pixel of the last middle (or, if there are two middle sub-areas, the left middle) sub-area 360 of a horizontal line structure which is encountered when searching downward from the top of the vectorized image 300. FIG. 6 illustrates the acceptable roof structures. Basically, a roof structure is defined as two sub-areas pointing upwards and askew towards each other, that is, 2, 3 or 4 as a left sub-area and 6, 7 or 8 as a right sub-area. FIG. 7 illustrates an acceptable horizontal line structure according to one embodiment of the present invention. Also, FIGS. 8 and 9 illustrate acceptable left and right endpoints, respectively, for an acceptable horizontal line structure according to one embodiment of the present invention. The acceptable left endpoint patterns shown in FIG. 8 have orientation numbers are 2; 3; 1 followed to the left by a 2, 3 or 4; 4 followed to the right by a 4; or 4 followed to the left by a 1. The acceptable right endpoint patterns shown in FIG. 9 have orientation numbers are 7; 8; 1 followed to the right by a 6, 7 or 8; 6 followed to the left by a 6; or 6 followed to the right by a 1.

Most fingerprints have roof structure ridges below multiple horizontal ridges which gradually increase in curvature towards the center of the fingerprint until a ridge is so curved as not to be considered either a roof structure or a horizontal line structure. In other words, the reference point located with this first procedure is the topmost point of the innermost upward curving ridge, that is, where the ridge almost curves, or does curve, back on itself.

To locate the reference point in the vectorized image 300, the first procedure begins by searching for a first horizontal line structure with endpoints having orientations pointing upwards and inwards. Then, the procedure searches downward until acceptable horizontal line structures and roof structures give way to other types of, though usually almost vertical, structures. Should this transition from horizontal line structures and roof structures not be found, the reference point sub-area 360 is presumed to have been missed. The first procedure indicates that the downward search has passed the reference point when the acceptable horizontal line structures begin to lengthen again, that is, become much longer. While searching upwards, the scan searches for a roof structure as in the downward search, but continues the search until the next horizontal line structure is encountered before selecting the reference point.

The reference point located according to the first procedure is stable over any number of images of the same fingerprint while also being located in an area with a high degree of information content, that is, an area with little redundant information such as parallel ridges. This location in a high information area aids in the matching procedure. Furthermore, this procedure locates the same reference point even if the fingerprint is presented at different angles with respect to the sensor. For example, the same reference point will be located even if one image of the fingerprint is rotated +/−20 degrees with respect to another image of the same fingerprint.

Locating the reference point is repeated for a multiple number of images of the same fingerprint to verify that the reference point is stable over these images and to ensure that when the fingerprint is later imaged for identification/-verification, the same reference point is located. In one embodiment, ten images were found sufficient.

While the present invention can operate with a vectorization using N orientations, with a minimum of N=2, the embodiment illustrated in FIG. 4, has eight possible orientations that is, N=8. In the embodiment shown in FIG. 4, each vector represents the predominant orientation of an 8 pixel by 8 pixel sub-area of the image. The size of the sub-area used for selecting an orientation generally corresponds to the resolution of the image. For example, an 8 pixel by 8 pixel sub-area is sufficient for a digital image of 500 dots per inch resolution. In FIG. 4, the eight orientations are evenly spaced but the direction of the orientations is not distinguished. For example, the vectors of 90 degrees and 270 degrees have the same orientation.

As illustrated in FIG. 5, each of the orientations can be assigned a number:

| Vector (degrees) | Orientation Number |
|---|---|
| 90 and 270 (vertical) | 1 |
| 67.5 and 247.5 | 2 |
| 45 and 225 (left oblique) | 3 |
| 22.5 and 202.5 | 4 |
| 0 and 180 (horizontal) | 5 |
| 157.5 and 337.5 | 6 |
| 135 and 315 (right oblique) | 7 |
| 112.5 aud 292.5 | 8 |
| non-defined, background | 0 |

Most conventional vectorization methods produce a good representation of the original image once the thresholds for the foreground and background of the image are determined. To define this boundary, in one embodiment of this invention and as illustrated in FIG. 4, boundaries of the vector image foreground are set according to the following rules, applied in order:

1. The orientation at the bottom of every column is vertical 370;

2. The orientation at the top of every column is horizontal 375;

3. The rightmost orientation of every row is right oblique 380; and

4. The leftmost orientation of every row is left oblique 385.

These boundary conditions allow the search for a reference point to start virtually anywhere in the vectorized image and iteratively follow a set procedure to locate the same reference point.

The downward search according to one embodiment of the present invention is described in further detail below, as Steps A, B, C and D and with reference to FIGS. 4-12.

Step A. (Start): Start at any sub-area in the foreground of the vectorized image. In one embodiment, the starting point 310 is the intersection of the vertical column of the geographic center of the image, and the horizontal row of one-third of the way to the top of the image from the geographic center.

Step B. (Search for first horizontal line structure): Search by following the orientation of each sub-area in the image generally upwards from sub-area to sub-area until a first horizontal line structure 320 is encountered. A first horizontal line structure 320 has a left endpoint 330 with an orientation number of 2, 3 or 4 and a right endpoint 340 with an orientation number of 6, 7 or 8. This first horizontal line structure search 500 is illustrated in FIG. 9 and is performed as follows:

| Current Sub-area | Next Sub-area |
|---|---|
| 1, 2 or 8 | move up one row |
| 3 or 4 | move up one row, move right |
| | one column |
| 5 | perform a left endpoint search |
| | for a first horizontal line structure |
| 6 or 7 | move up one row, move left one column |
| 0 | move down ten rows |

Orientation number 0 means the current sub-area is in the background 350 of the image which means that the search has moved too far up in the image. Therefore, the search moves ten rows downward before continuing. When a sub-area with a horizontal orientation, that is orientation number 5, is encountered, a search is made to determine if the first horizontal line structure has been found. If no first horizontal line structure is found after, for example, 100 iterations of Step B, this first procedure has failed to locate a reference point, and the second procedure is used.

The left endpoint search 510 for a first horizontal line structure is performed as follows:

| Current Sub-area | Next Sub-area |
|---|---|
| 1, 6, 7, 8 or 0 | move left one column, return to |
| | first horizontal line structure |
| | search |
| 2, 3 or 4 | move right one column, perform |
| | right endpoint search for first |
| | horizontal line structure |
| 5 | move left one column |

The right endpoint search 520 for a first horizontal line structure is performed as follows:

| Current Sub-area | Next Sub-area |
|---|---|
| 1, 2, 3, 4 or 0 | move right one column, return to |
| | first horizontal line structure |
| | search |
| 5 | move right one column |
| 6, 7, 8 | begin downward search |

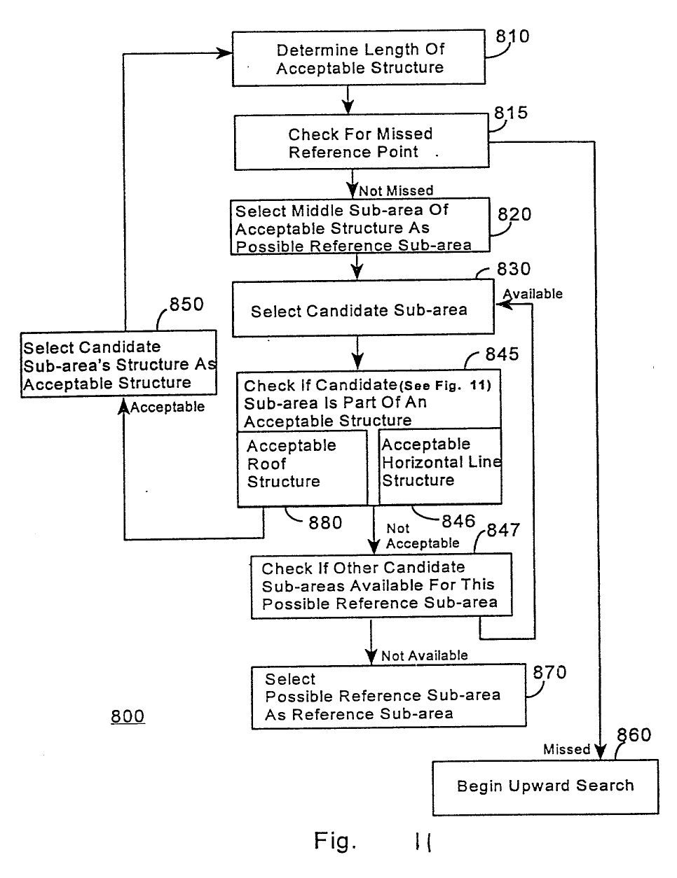

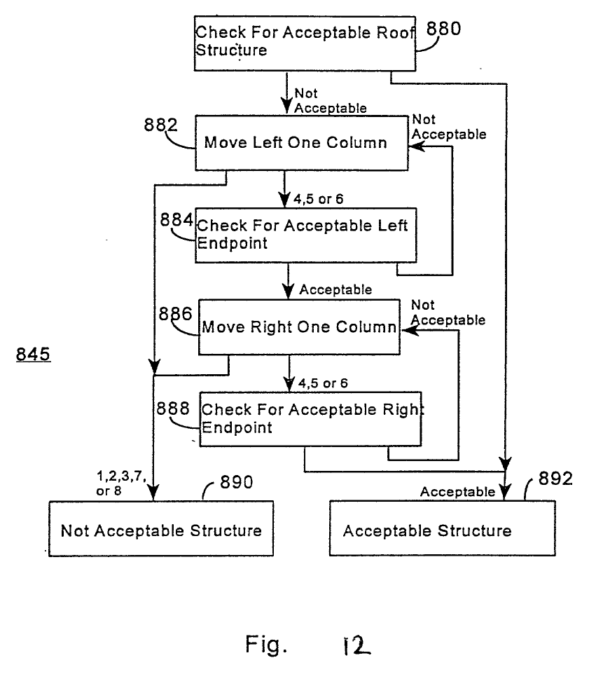

Step C. (Downward Search): Searches downwards from the first horizontal line structure 320 until the reference point is found, or the search has skipped the reference point. A skipped reference point is indicated by the length of the acceptable horizontal line structures because above the reference point the acceptable horizontal line structures get smaller in the downward direction, but below the reference point the acceptable horizontal line structures get longer in the downward direction. This downward search procedure is illustrated in FIG. 11. Roof structures, as illustrated in FIG. 6, can be considered the shortest acceptable horizontal line structures and are acceptable structures. Also, while the first horizontal line structure 320 is a type of acceptable horizontal line structure, acceptable horizontal line structures encompass a greater degree of variation, see FIGS. 7 and 12.

The first step in the downward search is to determine the length 810 of the current acceptable structure 600 by counting the number of sub-areas of the acceptable structure. Then, as illustrated in FIGS. 7, 11 and 12, select 820 the middle sub-area 605 of the acceptable structure as the possible reference sub-area and investigate 830 the following candidate sub-areas, in the following order: (1) down one row 610; (2) down one row, left one column 620; (3) down one row, right one column 630; (4) down one row, left two columns 640; (5) down one row, right two columns 650.

If any of these candidate sub-areas are part of an acceptable structure 845, 847 select this acceptable structure 850 for determining the next middle sub-area for the next iteration of step C. However, if the length of the acceptable structure 600 is much longer, for example six times longer, than the shortest length of the acceptable structures encountered so far 815, the reference point is considered to have been skipped and an upward search needs to be performed 860, see Step D.

If no acceptable structure, that is, a horizontal line or a roof structure, has been located among the candidate sub-areas 847, the possible reference sub-area is, in fact, the actual reference sub-area 360, and the center pixel of the actual reference sub-area is the reference point.

The acceptable horizontal line structure search 846 is performed as follows:

| Current Sub-area | Next Sub-area |
|---|---|
| 1, 2, 3, 7, or 8 | select next candidate sub-area |
| 4, 5 or 6 | perform acceptable left |
| | endpoint search |

The acceptable left endpoint search 882, 884 is performed as follows:

| Current Sub-area | Next Sub-area |
|---|---|
| 4, 5 or 6 | move left one column, |
| | check for acceptable left |
| | endpoint |
| 1, 2, 3, 7, or 8 | select next candidate sub-area |

If an acceptable left endpoint is found, the acceptable right endpoint search 886, 888 is performed as follows:

| Current Sub-area | Next Sub-area |
|---|---|
| 4, 5 or 6 | move right one column, check for |
| | acceptable right endpoint |
| 1, 2, 3, 7, or 8 | select next candidate sub-area |

If both an acceptable right endpoint and an acceptable left endpoint are found 892, the horizontal line structure is acceptable and the middle sub-area of this acceptable horizontal line structure is used to determine the next candidate sub-areas.

Step D. (Upward Search) Searches upwards according to similar rules as Step C, except the search for acceptable structures is performed in the upward directions.

Thus, according to one embodiment of the present invention, a stable reference point can be identified by locating the first point in the fingerprint image, scanning downward, which has a greater curvature than even the roof structures, for example, a left sub-area orientation of 1 and a right sub-area orientation of 8. Since the structures above this point are common to virtually all kinds of fingerprints, that is, primarily parallel meandering ridges, finding a starting point and then searching downwards will almost always locate a stable reference point.

The second procedure, according to one embodiment of the present invention, may be used to locate the geographic center when the first procedure 152 fails to locate the reference point. As already mentioned, it could also be used on its own as an alternative to the first procedure.

The geographic center of the binarized fingerprint in the binarized image may be defined as the pixel in the foreground of the image where the same number of pixels are located above the point as below and the same number of pixels are located to the right as to the left. Thus, the foreground of the image must be separately identified from the background.

In one embodiment of the present invention, the boundary of the foreground is determined using the variance of the pixel values. The pixel values only vary slightly over the entire background, whereas in the foreground the pixel values vary significantly because the ridge structures have significant variation between the valleys which, in one embodiment of the present invention, are white and the ridges which, in one embodiment of the present invention, are black. Thus, by calculating the variance of the pixels, the boundary between the foreground and background can be determined.

An alternative procedure for locating the foreground boundary of the image is to find the first pixel of every row and column that corresponds to a part of a ridge when searching toward the center of the binarized image 200 from each edge of the image. In one embodiment of the present invention such a pixel has a value higher than a certain threshold whereas the background has pixels having values below the certain threshold. Because the ridges are in the foreground, the pixels so located define the boundary of the foreground.

Once the foreground boundary has been determined, the number of foreground pixels in each row and column are counted and the column that has as many foreground pixels to the left as to the right and the row that has as many foreground pixels above as below are selected as the coordinates of the reference point for the image.

An alternative first or second procedure for finding a reference point is based on ridge counting using the binarized, restored image. In this alternative procedure, the number of ridges crossing each vertical and horizontal grid line in the image are determined. The point where the row and the column having the highest respective ridge counts intersect is selected as a starting point. This row is selected as the reference point row. From this starting point, a search follows along three neighboring ridges to the topmost point (lowest row number) and this column is selected as the reference point column. These two steps, are described in greater detail below as Steps A and B.

A. Along each row and column, the search counts all transitions from black to white and white to black. Then the search selects the point (row, column) with the highest ridge count, that is the greatest number of transitions, as a starting point, or if three or more rows/columns having the same ridge count, the middle row/column is selected.

B. Using the row value from the starting point, the search then selects the reference point column by following the ridge closest to the starting point and the two closest neighboring ridges upwards to the respective top points. The average of these three ridge top points is selected as the reference point column.

As yet another alternative first or second procedure, the reference point may also be determined by selecting a predetermined point in the image, i.e. a predetermined point in the coordinate system of the sensor. The centre point of the sensor, and thus of the image, may for instance be used as the reference point.

An advantage of selecting a predetermined point in the image as the reference point is that it is very simple and reliable, and it may work for all kind of fingerprints. An advantage of selecting the centre point is that the user mostly puts his finger so that it covers the centre point. Often, the user also puts his finger so that the middle part thereof covers the centre point, such that the reference point will be located in the middle of the fingerprint in the image. An advantage of this is that the middle part of the fingerprint usually is the part less distorted.

The above-described methods are but examples of how a reference point defining a specific point in the fingerprint can be found. Other methods of locating a reference point by searching the image to locate a specific point in the fingerprint on the basis of the binarized ridge and valley information are also conceivable.

Recognition template selection 160: After the reference point has been determined, a first portion or region of the captured image in the vicinity of the reference point may be selected for storage as part of a recognition template. As will be explained in the following, this first portion of the image may be used, in a verification or identification process, as a reference portion to establish a corresponding reference point in a sample fingerprint image.

The first portion of the image may centered around the reference point, i.e. with the centre point of the first portion as the reference point. An advantage of this location of the first portion of the image is that it reduces the risk that distortion results in an incorrectly established reference point in a later captured image. As an alternative, the first portion of the image may be selected in another predetermined relationship to the selected reference point, preferably, but not necessarily, such that the reference point is located within the first portion of the image.

When the reference point and the first image portion have been selected, further portions of the binarized image may also be selected for use as part of the recognition template. In one embodiment of the present invention, four to eight further portions are selected, each further portion having a size of e.g. 48 pixels by 48 pixels. The further portions can be selected to be neighboring, proximate, or in the vicinity of the first portion. However, this invention also encompasses first portions and first portions of different sizes, shapes and more distant locations. The size, shape and location of the portions can be selected so as to maximize the useful information in accordance with, for example, the number of pixels available from the sensor, or other considerations.

The further image portions can be selected based on fixed positions relative to the first portion or reference point, or in one embodiment, the fingerprint binary image can be scanned for features and each of the feature locations can be used as the basis for defining further portions. By selecting further portions including features, more information is stored than when further portions containing parallel ridges are selected. More information is conveyed in features because features have less redundant information than parallel ridges and, thus, are more easily distinguished when compared. The features are initially located using conventional methods, for example, following a ridge line to the point where the ridge ends or splits (bifurcates). Once identified, the further portions are selected to include as many feature locations as possible thereby maximizing the amount of useful information being stored. However, if the image lacks a sufficient number of features for the number of further portions required, the remaining further portions can be selected using default locations.

Once selected the first and further portions of the image, i.e. the pixels thereof, are stored as part of the recognition template. Moreover relative location information, which indicates the locations of the further portions relative to the determined reference point may be stored as part of the recognition template. The relative location information may be in the form of difference coordinates or vectors. The template may have a predetermined format, so that e.g. the different image portions are stored in a predetermined order. The reference point need not be stored in the recognition template, since it has a predetermined relationship to the first image portion. However, the template may, when applicable, include a bit or flag indicating whether the enrollment procedure was able to locate a reference point with the aid of the vectorization procedure. Further information may be stored in the recognition template, such as different matching requirements or threshold values. All or part of the recognition template may be compressed and/or encrypted before being stored.

The quality check, the binarization, the restoration, the reference point determination and the selection of the recognition template may be carried out by a processor, e.g. processor 20 of FIG. 1. The recognition template may be stored in the template storage 30 of FIG. 1.

In another embodiment of the invention, the image capture 110, the quality check 120, the binarization 130 and the restoration 140 are carried out as described above. Then, in a combined reference point determination and recogition template selection step, the binarized image is searched for image portions which satisfy one or more predetermined criteria.

The image may be searched for portions with a high degree of uniqueness, at least compared with their closest environment. Since the image portions are to be used in a recognition template and are to be matched against later captured images to verify an identity, it may be advantageous that their matching position can be unambigiously determined.

The uniqueness of an image portion may be determined by correlating it with its environment. A low correlation result is an indication of high local uniqueness.

The uniqueness may also be established by studying the curvature of the lines in the image portion.

Yet another way of finding a unique portion of the image may be to search the image for features and to select a portion of the image including as many features as possible.

Closeness to the centre of the image is another criterion which may be used in addition to uniqueness to find suitable image portions. Assuming that the user normally places his finger centrally on the sensor, closeness to the centre of the image will also imply closeness to the centre of the fingerprint, which will usually be the part less affected by distortion.

A further criterion used for selecting image portions may be distinctness, i.e. how easy it is to binarize the image portions.

When a predetermined number of image portions which satisfy the predetermined criterion have been found, one of them are selected as a first image portion, in relation to which the reference point is determined. The first image portion may for instance be the most central one of the image portions. The reference point is selected as a point having a predetermined relationship to the first image portion. It is preferably selected as the center point of the first image portion. Alternatively, it can be selected as another predetermined point within or in the vicinity of the first portion. Then a recognition template comprising the first image portion, the further selected image portions, relative location information indicating the relative locations of the further image portions with regard to the reference point, and any other relevant information, such as matching threshold values, are stored in a recognition template.

According to yet another embodiment, features may be used for determining a reference point. According to this embodiment the image capture 110, the quality check 120, the binarization 130 and the restoration 140 are carried out as described above. In a reference point determination step 150 the image is, however, searched for features. Then a reference point is selected in a predetermined relationship to the features. One of the features may for instance be selected as the reference point.

Then, in the recognition template selection step 160, a first image portion is selected. It may be centered on the feature selected as the reference point or selected in any other predetermined relationship to the reference point. Further image portions are also selected. They can be selected in predetermined relationships to the features or by searching the image for image portions which satisfy a predetermined criterion as described above. The first image portion may also be selected in this way.

Finally, information about the features found in the image is stored in the recognition template. The information may comprise the locations of the features. It may also comprise the orientations of the features and/or the types of features. The first and further image portions and the relative location information are also stored in the recognition template. Any other required information may also be stored in the recognition template.

The quality check, the binarization, the restoration and the reference point selection may be performed in the signal processor 20 of FIG. 1.

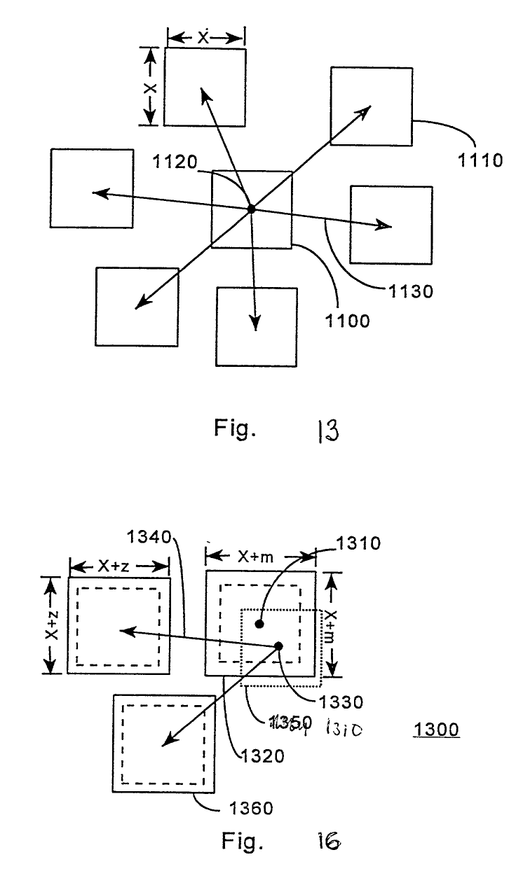

As illustrated in FIG. 13, in one embodiment of this invention, an image portion centered on the reference point 1120 is selected as a ‘first image portion 1100’. This first image portion, according to one embodiment of the invention, is a square having a size of 48 pixels by 48 pixels, approximately covering three ridge widths. Also, further image portions 1110 of the binarized image are selected for storage in the recognition template. In one embodiment of the present invention, four to eight further image portions 1110 are selected, each having a size of 48 pixels by 48 pixels. The further image portions have relative locations with regard to the reference point 1120. The relative locations are illustrated by vectors 1130 in FIG. 13.

As illustrated in FIG. 14, in one embodiment of this invention, fingerprint feature locations 1400 are located. One fingerprint feature location 1410 is selected as a reference point. A first image portion 1420 is centered on the reference point. Further image portions 1430 are centered on other feature locations. Another image portion 1440 is not centered on a feature location. The further image portions have relative locations illustrated by vectors 1450.

Matching Procedure

One embodiment of a matching procedure is described below. This matching procedure can be used for both identification and verification. If verification is desired, a particular recognition template, such as for example, a template stored on a smart card, is compared to a sample image. If identification is required, a search of a recognition template database may be performed based on particular characteristics of the sample image information to locate potential matching recognition templates. Identification, therefore, requires a series of matching procedures.

Image Capture 1202: The first step of the matching procedure is to capture a sample image of a fingerprint of a person who is to be identified or whose identity is to be verified. The sample image is captured by a fingerprint sensor, e.g. sensor 10 in FIG. 1. When a finger is pressed against the sensor to capture the sample image of the fingerprint, the percentage of black pixels change from approximately zero to around 50% of the pixels. In one embodiment, a threshold is used to determine whether a sufficient number of pixels have become black so that matching can be performed. embodiment a plurality of sample images are captured.

Quality Check 1204: If time permits, a quality check 1204, similar to the quality check 120 for enrollment 100 can be performed on the sample image.

Binarization 1208: The sample image may be binarized in the same way as an enrolled image.

Restoration 1210: If time permits, image restoration 1210 similar to the restoration 140 for enrollment 100 can be performed on the sample image.

It should be emphasized that the invention is not restricted to the above-described particular preprocessing steps (quality check, binarization and restoration steps), as regards neither the enrollment procedure, nor the matching procedure.

The steps of quality check, binarization and restoration may be performed by a signal processor, e.g. signal processor 20 in FIG. 1.

Sample image reference point determination 1230: In one embodiment, this step comprises that the first portion or reference portion of the recognition template is selected and correlated with at least part of the sample image. The purpose of this correlation may be to determine and select a reference point in the sample image which corresponds to the reference point in the first portion of the recognition template. The purpose may also be to determine the approximate rotation of the sample image in relation to the recogition template.

In one embodiment the first image portion of the recognition template is correlated with an X+m pixels by X+m pixels, e.g. 100 pixels by 100 pixels, part area at the centre of the sample image. The correlation is carried out with different translational shifts, so that many or all possible correlation positions are examined. For each correlation position a correlation result is obtained.

The first image portion of the recognition template may also be rotationally shifted in order to obtain correlation results for different rotational positions.

Correlation for this invention is meant in its broadest sense, that is, a pixel-by-pixel comparison between an image portion of the recognition template and an image portion of the sample image. Correlation at its simplest, means that if a pixel in the template image portion matches a pixel in the sample image portion, a fixed value, such as “1”, is added to a total. If the pixel in the template image portion does not match the pixel in the sample image portion, no addition is made to the total. When each pixel in the template image portion and the sample image portion have been compared, the total indicates the amount of correlation between the template image portion and the sample image portion. Thus, for example in one embodiment, a match value between 0%, that is zero, and 100%, that is one, is obtained from the correlation. 0% indicates a complete mis-match and 100% indicates a perfect match. Of course, other types of correlation are encompassed by this invention, including: (1) multiplying each pixel in the template image portion by the corresponding pixel in the sample image portion and integrating to obtain the correlation; and (2) logically ‘XOR-ing’ (exclusive OR) each pixel in the template image portion by the corresponding pixel in the sample image portion and taking the summation of the results. Thus, if gray-scale sample images and templates are used instead of a binarized sample images and templates, correlation can still be performed in accordance with the present invention. In one embodiment, a threshold value between 0% and 100% is selected to determine an acceptable match (‘thresh middle’). If the match is not acceptable, different image portions of the sample image centre part are selected and additional correlations are performed. As already mentioned, these other portions can be rotationally and/or positionally shifted with respect to each other within the centre part. In one embodiment, rotation steps of between 2 degrees and 5 degrees were found sufficient to achieve acceptable matching values. Thus, the sample image could be rotated ±180 degrees or more with respect to the first image portion of the recognition template. In another embodiment, the results of each correlation is used to determine the selection of the next portion of the sample image to correlate with the first portion of the recognition template until a maximum match value is identified. Then a point, which has the same relationship to the maximum match image portion of the sample image as the reference point selected during enrollment has to the first image portion of the recognition template, is selected as the sample image reference point. Thus, if the reference point selected during the enrollment procedure is the centre point of the first image portion, then the centre point of the maximum match image portion of the sample image is selected as the sample image reference point.

The correlation procedure according to one embodiment of the present invention is discussed below with respect to three scenarios, A, B, and C:

Successive sample image portions within the X+m pixel by X+m pixel area are correlated with the first image portion of the recognition template until all the desired portions have been correlated. The desired portions can be rotations and or position shifts relative to the sample image reference point.

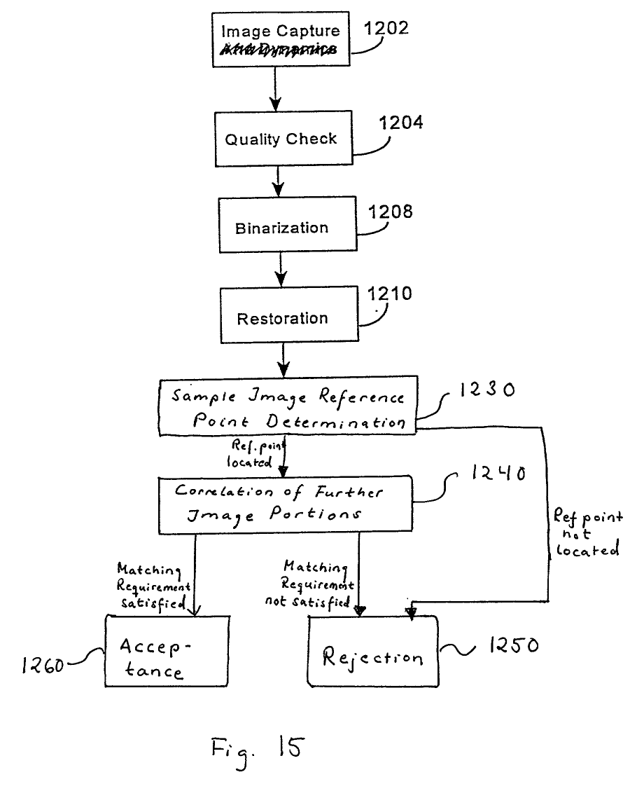

A: If no match is found, ‘m’ is increased in size, that is, sample image center part is enlarged, and additional correlations are performed with the recognition template's first image portion. If still no match is found, the user is then rejected, step 1250 in FIG. 15.

B: If only one image portion of the sample image center part is successfully matched, that is, has a match value higher than thresh middle, that portion is selected as the maximum match image portion and the sample image reference point is selected in the predetermined relationship thereto.

C: If more than one image portion of the sample image center part exceeds thresh middle and one of these portions has a significantly higher match value, that portion is selected as the maximum match image portion and the sample image reference portion is selected in the predetermined relationship to this image portion. However, if several portions have approximately the same match value, each of these portions may be selected for subsequent use in this matching procedure.

The reference point determination may be performed by a processor, e.g. processor 20 in FIG. 1.

Correlation of Further Image Portions 1240: Once a maximum match image portion is selected, it can be used as the basis for the correlations of further image portions. More particularly, the entire binarized sample image is rotated to correspond to the rotation of the maximum match image portion. Then, the relative location information for each of the further image portions stored in the recognition template is used to locate a respective further image portion in the sample image. The size of each further sample image portion, in one embodiment, is selected to be a square of X+z pixels by X+z pixels, where z is selected be less than m. Then, a similar correlation procedure is performed with respect to the procedure used for the center part correlation, except that the further template image portions are correlated with fewer translational and rotational shifts in relation to the sample image portions than what was used when correlating the first template image portion.

If a single maximum match image portion could not be determined, but several best match image portions were selected, the above-described selection of further sample image portions and correlation of these with the further image portions of the recognition template are repeated for each on of the best match image portions.

Various match parameters can be set by a system manager. For example, the threshold value for an acceptable match value for the first image portion and/or a further image portion, the number of image portions to correlate, and/or the number of image portions achieving an acceptable match value to accept a fingerprint as a match, can be set directly by the system manager. The system manager can also set these match parameters indirectly by selecting a desired security level, for example, between 1 and 10. For example, in one embodiment, if two further image portions fail to match, the user is rejected, step 1250 in FIG. 15, even if the first image portion matched. Also, the various match parameters may be included as part of the recognition template and retrieved therefrom at the time of matching.

Depending on the security needs of a particular installation, the number of image portions stored in the recognition template can be selected at enrollment. Thus, for example, the recognition template for access to a high security building can include ten image portions, whereas for a low security building, perhaps only three image portions need be stored in the recognition template.

Acceptance 1260: The user is accepted, that is matched, if the requirements for the selected matching parameters have been satisfied. In one embodiment of the present invention, all but one of the image portions compared must match, and a sufficient number, for example, between 3 and 10, of the image portions must have been available for correlation. An image portion may not be available if the sample image is of a low quality w11, or if the image portion is not present in the sample image.

In the above-described embodiment, the user providing the sample image may be rejected if a correlation result which satisfies the matching requirement is not obtained when correlating the first portion of the recognition template with the center part of the sample image. Sometimes this may happen in despite of the person from which the sample image is obtained being the same as from which the recognition template is obtained. One reason may be that the person places his finger in such a position on the sensor that the part corresponding to the first image portion of the recognition template is not within the sensor surface. Another reason may be that the person has a wound or scar in the part corresponding to the first image portion of the recognition template.

This problem may be solved by switching to a second image portion of the recognition template and repeating the above-described correlation procedure. If the matching requirement is satisfied for this second portion, a sample image reference point is selected in the above-described predetermined relationship to the maximum match image portion of the sample image. Otherwise further image portions of the recognition template may be tried, until all portions have been tried and the sample image is rejected, step 1250 in FIG. 15.

Then the relative location information is recalculated so that it reflects the relative locations of the other image portions of the recognition template with regard to a reference point having the predetermined relationship to the second image portion. After that the further image portions of the sample image may be selected and correlated as described above.

Another embodiment of the matching procedure is used in connection with recognition templates which include features. In this embodiment, the image capture 1202, the quality check 1204, the binarization 1208, and the restoration 1210 may be carried out as described above. However, in the sample image reference point determination step 1230, the binarized sample image is searched for locations of fingerprint features. The feature locations found are compared with the feature locations of the recognition template in order to determine how the template and the sample image are positioned in relation to each other. The correlation result must satisfy a matching requirement, which may comprise that no feature location in the sample image must deviate from the corresponding feature location in the recognition template by more than a predetermined number of pixels. If the matching requirement is not satisfied, the sample image is rejected, step 1250 in FIG. 15. If the matching requirement is satisfied, a sample image reference point is selected so that it corresponds to the reference point used for the recognition template. If e.g. the reference point of the recognition template is a specific feature of the enrolled fingerprint, then the corresponding feature of the sample image is selected as the reference point. Thereafter image portions in the sample image may be selected on the basis of the relative location information in the recognition template and correlated as described above, steps 1240-1260.

FIG. 16 illustrates one embodiment of the matching procedure 1300. A first image portion 1310 of the recognition template is selected and correlated with a center part 1320 of the sample image. In one embodiment the center part 1320 is a square having a size of X+m pixels by X+m pixels, where X is the size of the first image portion 1310 and m is selected to be between X divided by 4 (X/4) and 2 multiplied by X (2*X). The center point 1330 of that image portion for which a maximum match correlation result is obtained is selected as the sample image reference point in one embodiment of the invention. Further image portions of the sample image are selected by using the relative location information in the recognition template. The relative location information is illustrated by vectors 1340 in FIG. 16. The size of the further image portions are X+z, where z is selected to be less than m.

The above-described matching procedures may be used in connection with a smart card which stores a recognition template for its owner. It is desirable, for security reasons, that the template never leaves the card. Thus, the matching procedure should be carried out on the smart card. However, the processing capacity of a microprocessor on a standard smart card is usually not sufficient for carrying out any one of the above-described matching procedures. To solve this problem part of the matching procedure can be carried out outside the smart card.

In one embodiment a sample fingerprint is sensed by a fingerprint sensor, e.g. sensor 10 in FIG. 1, and a sample image is created. The sample image is preprocessed by a processor, e.g. processor 20 in FIG. 1. The preprocessing may include quality checking, binarization and restoration. In one embodiment features may also be located in the sample image. Thereafter the preprocessed image is sent to the smart card, where the remaining part of the matching procedure is carried out.

In another embodiment, the sample image is also preprocessed in a processor unit, e.g. the processor 20 in FIG. 1. Then the first image portion of the recognition template is retrieved from the smart card, e.g. the template storage 30 of FIG. 1, and correlated in the processor unit 20 with the center part of the sample image in order to determine a sample image reference point and the relative rotation of the enrollment image and the sample image. When the sample image reference point has been determined, further sample image portions are determined in the processor unit 20. For this step relative location information in the recognition template may be retrieved from the smart card. Once selected, the further sample image portions are transferred to the smart card, where correlation of the sample image portions with the further recognition template image portions is carried out and the final matching decision is made, possibly with the aid of matching requirements stored in the recognition template.

One concern of using bitmaps for fingerprint matching is that if an unauthorized party somehow obtains the stored fingerprint image information, duplicates of the fingerprint, or images thereof, could be reconstructed. However, with the present invention, such reconstruction is impossible because the complete fingerprint bitmap is not stored in the recognition template. Instead, only selected portions of the fingerprint image are stored. Further, in one embodiment of the present invention, the location of these image portions, that is, the location information is encoded and/or encrypted.

Thus, it is apparent that in accordance with the present invention an apparatus and method that fully satisfies the objectives, aims, and advantages is set forth above. While the invention has been described in conjunction with specific embodiments and examples, it is evident that many alternatives, modifications, permutations, and variations will become apparent to those skilled in the art in the light of the foregoing description. Accordingly, it is intended that the present invention embrace all such alternatives, modifications and variations as fall within the scope of the appended claims.

What is claimed is:

1. A fingerprint enrollment method comprising the steps of obtaining an image of a fingerprint, selecting a first portion of the image, which has a predetermined relationship to a reference point, and storing a recognition template, which comprises said first portion of the image.

2. The fingerprint enrollment method according to claim 1, further comprising the step of selecting a reference point in the image.

3. The fingerprint enrollment method according to claim 2, wherein the step of selecting a reference point comprises selecting a predetermined point of the image as the reference point.

4. The fingerprint enrollment method according to claim 2, wherein the step of selecting the first portion of the image comprises selecting a portion of the image in the vicinity of the reference point.

5. The fingerprint enrollment method according to claim 1, wherein said step of selecting a first portion comprises searching the image for a portion which satisfies at least one predetermined criterion.

6. The fingerprint enrollment method according to claim 5, wherein the image is searched for a portion with a predetermined degree of uniqueness.

7. The fingerprint enrollment method according to claim 6, wherein the image is searched for a portion which also has a predetermined closeness to the center of the image.

8.The fingerprint enrollment method according to claim 2, wherein the step of selecting a reference point comprises selecting a point within the selected first portion of the image as the reference point.

9. The fingerprint enrollment method according to claim 8, wherein said step of selecting a reference point comprises selecting the center point of the first portion of the image.

10. The fingerprint enrollment method according to claim 1, further comprising the step of selecting at least one further portion of the image and storing said further portion as part of the recognition template.

11. The fingerprint enrollment method according to claim 10, wherein said further portion of the image has a relative location with respect to the reference point and wherein the method further comprises the step of storing information about said relative location as part of the recognition template.

12. The fingerprint enrollment method according to claim 10, wherein said step of selecting at least one further portion comprises searching the image for a portion which satisfies at least one predetermined criterion.

13. The fingerprint enrollment method according to claim 1, further comprising the step of searching the image to locate a reference point in the fingerprint.

14. A fingerprint enrollment method, comprising the steps of obtaining an image of a fingerprint, selecting a plurality of portions of the image, and storing a recognition template which comprises said plurality of portions of the image.

15. The fingerprint enrollment method according to claim 14, further comprising the step of selecting a reference point in a predetermined relationship to one of the portions of the image and storing, as part of the recognition template, information about the location of the other selected portions of the image relative to the reference point.

16. The fingerprint enrollment method according to claim 14, wherein said plurality of portions of the image are selected by searching the image for portions that satisfy at least one predetermined criterion.

17. The fingerprint enrollment method according to claim 16, wherein said plurality of portions of the image is selected based on their degree of uniqueness.

18. The fingerprint enrollment method according to claim 17, wherein said plurality of portions of the image are selected also based on their closeness to the centre of the image.

19. The fingerprint enrollment method according to claim 15, wherein the reference point is selected to be within one of said plurality of portions of the image.

20. A fingerprint enrollment method, comprising the steps of obtaining an image of a fingerprint, searching the image for locations of fingerprint features, selecting at least one portion of the image, and storing a recognition template comprising the fingerprint locations and the at least one portion of the image.

21. The fingerprint enrollment method according to claim 20, further comprising the step of selecting a reference point in a predetermined relationship to one of said features.

22. The fingerprint enrollment method according to claim 21, further comprising the step of storing relative location information, which indicates the location of the image portion with regard to the reference point, as part of the recognition template.

23. A fingerprint matching method comprising the steps of obtaining a sample image of a fingerprint, correlating an image portion of a recognition template, which comprises at least one portion of another image, with at least part of the sample image to generate a correlation result, and determining whether the correlating result exceeds a predetermined matching requirement.

24. The fingerprint matching method according to claim 23, further comprising the step of determining a sample image reference point on the basis of the correlation result.

25. The fingerprint matching method according to claim 24, wherein the recognition template comprises further portions of the other image and wherein corresponding further portions of the sample image are selected by using the sample image reference point.

26. The fingerprint matching method according to claim 25, wherein the recognition template comprises relative location information indicating the relative locations of the further portions of the other image with regard to a reference point in the other image and wherein the further portions of the sample image are selected by using the relative location information.

27. The fingerprint matching method according to claim 25, wherein the recognition template comprises relative location information indicating the relative locations of the further portions of the other image with regard to a reference point in the other image and wherein the method comprises the further step of using the relative location information to select the further portions of the sample image in substantially the corresponding relative locations with regard to the sample image reference point.

28. The fingerprint matching method according to claim 25, further comprising correlating the further portions of the other image with the further portions of the sample image to obtain a correlating result for the further portions of the sample image, and determining whether the correlation result exceeds a predetermined matching criterion.

29. The fingerprint matching method according to claim 28, comprising the step of repeating the correlating step and the determining step for a second portion of said plurality of portions of the other image if the correlation result for the first portion is below the matching requirement.

30. The fingerprint matching method according to claim 29, wherein the recognition template comprises relative location information indicating the relative locations of the portions of the other image with regard to a predetermined reference point within the first portion, recalculate the relative location information so that it indicates the relative locations of the plurality of portions of the other image with regard to a predetermined reference point within the second portion and selecting the further portions of the sample image by using the recalculated relative location information.

31. A fingerprint matching method, comprising the steps of obtaining a sample image of a fingerprint, searching the sample image to obtain locations of fingerprint features, correlating the fingerprint feature locations of the sample image with fingerprint feature locations of a recognition template to obtain a first correlation result, determining a sample image reference point on the basis of the first correlation result, selecting a sample image portion in a predetermined relation to the sample image reference point and correlating the sample image portion with an image portion of the recognition template to obtain a second correlation result and determining whether the second correlation result exceeds a matching requirement.

32. The fingerprint matching method according to claim 31, wherein the recognition template comprises relative location information indicating the location of the template image portion with regard to a predetermined reference point and selecting the sample image portion based on the relative location information and the sample image reference point.

33. A computer-readable medium having stored thereon a computer program, comprising instructions for causing a computer to carry out a fingerprint enrollment method comprising the steps of selecting a first portion of an image of a fingerprint, said first portion having a predetermined relationship to a reference point, and storing a recognition template, which comprises said first portion of the image.

34. A computer-readable medium having stored thereon a computer program, comprising instructions for causing a computer to carry out a fingerprint enrollment method comprising the steps of selecting a plurality of portions of an image of a fingerprint, and storing a recognition template which comprises said plurality of portions of the image.

35. A computer-readable medium having stored thereon a computer program, comprising instructions for causing a computer to carry out a fingerprint matching method comprising the steps of correlating an image portion of a recognition template, which comprises at least one portion of another image, with at least part of a sample image of a fingerprint to generate a correlation result, and determining whether the correlating result exceeds a predetermined matching requirement.

36. A fingerprint processing device comprising a sensor for sensing a fingerprint; a processor for receiving an image of the fingerprint sensed by the sensor and for selecting a first portion of the image, said first portion having a predetermined relationship to a reference point, and a storage device for storing a recognition template, which comprises said first portion of the image.

37. A fingerprint processing device comprising a sensor for sensing a fingerprint; a processor for receiving an image of the fingerprint sensed by the sensor and for correlating an image portion of a recognition template, which comprises at least one portion of another image, with at least part of the sample image to generate a correlation result, and determining whether the correlating result exceeds a predetermined matching requirement.

38. A fingerprint recognition template for a fingerprint processing system comprising a first portion of an image of a fingerprint, further portions of the image and relative location information corresponding to the location of each of the further image portions with respect to a predetermined reference location defined by the first image portion.
